(19) United States
(12) Patent Application Publication
(10) Pub. No.: US 2017/0232423 A1
(43) Pub. Date: Aug. 17, 2017

(54) PHOTOCATALYIC COATING

(71) Applicant: 3M INNOVATIVE PROPERTIES COMPANY, St. Paul, MN (US)

(72) Inventors: Feng Bai, Woodbury, MN (US); Rachael A.T. Gould, Forest Lake, MN (US); Mark T. Anderson, Woodbury, MN (US)

(21) Appl. No.: 15/586,074

(22) Filed: May 3, 2017

Related U.S. Application Data
(63) Continuation of application No. 15/248,124, filed on Aug. 26, 2016.
Application No. 15/248,124 is a continuation of application No. 12/519,850, filed on Jun. 27, 2011, now abandoned.
(60) Provisional application No. 60/871,583, filed on Dec. 22, 2006.

(51) Int. Cl. B01J 23/04; B01J 21/08; C09D 7/12; C09D 1/04; C04B 20/10; B01J 21/06; B01J 35/00

(52) U.S. Cl. CPC B01J 23/04; B01J 21/063; B01J 21/08; B01J 35/004; C09D 1/04; C04B 20/1074; C04B 20/1066; C09D 7/1216; C09D 7/1225; C04B 2111/00827

(57) ABSTRACT

In one aspect, the present invention is directed to a coating composition. The coating composition comprises photocatalytic particles and an alkali metal silicate binder comprising an alkoxysilane. In another aspect, the present invention is directed to a coated article. The coated article has a photocatalytic coating with improved durability on its external surface that is formed from the aforesaid coating composition.

### FIELD OF INVENTION

The present invention relates to a coating composition and a coated article having a photocatalytic coating formed therefrom, particularly with application to building materials, such as, for example, roofing granules.

### BACKGROUND

Discoloration of construction surfaces due to algae growth or other agents has been a problem for the construction industry for many years. Discoloration has been attributed to the presence of blue-green algae and other airborne contaminants, such as soot and grease.

One approach to combating this problem is to coat the construction surfaces with a composition that contains photocatalysts and a binder, typically a silicate binder. When exposed to sunlight, the photocatalysts may photo-oxidize the organic materials that cause the discoloration.

Photocatalytic titanium dioxide (TiO₂) particles can be used, for example, in roofing granules, to provide photocatalytic activity. To achieve long-term photocatalytic performance, a relatively high amount of silicate can be used in the coating composition. This may impact the color of the coated granules and reduce their photoactivity.

### SUMMARY

The present invention is directed to a coating composition and a coated article resulting from the application of the coating composition.

The coating composition of the present invention generally includes photocatalytic particles and an alkali metal silicate binder comprising an alkoxysilane. Preferably, the photocatalytic particles are transition metal catalysts. Particularly preferred photocatalysts include crystalline anatase TiO₂, crystalline rutile TiO₂, crystalline ZnO and combinations thereof. The photocatalytic particles used in the coating composition typically have a mean particle size in the range of about 1 nm to about 1000 nm. Preferred mean particle size is in the range of about 1 nm to about 200 nm, with a most preferred range of about 1 nm to about 100 nm. The coating composition has a solid weight percentage of the photocatalytic particles in the range of about 0.1% to about 90%. Preferred weight percentage is in the range of about 30% to about 80%, with a most preferred range of about 40% to about 70%. Alkali metal silicate binders suitable for use with the present invention include lithium silicate, sodium silicate, potassium silicate, and combinations thereof.

Representative alkoxysilanes suitable for use with the present invention include any compounds having a structural unit of Si(R₁)ₙ(OR₂)₄₋ₙ or dimers or oligomers formed from this structural unit, or combinations thereof, where R₁ and R₂ are independent organic groups having carbon number from 1 to 18, and n is an integer from 0 to 2. A preferred alkoxysilane is tetraethoxysilane (TEOS). The solid weight percentage of the alkoxysilane used in the coating composition is typically more than about 0.1%. The preferred weight percentage is more than about 10%, with a most preferred percentage of more than about 15%.

Applying the coating composition onto a base article, followed by heating to elevated temperatures in a rotary kiln, oven or other suitable apparatus, produces a photocatalytic coating with improve durability. Preferred articles include building materials susceptible to discoloration due to algae growth or other agents, such as airborne particulates of dust, dirt, soot, pollen or the like. One particularly preferred article is roofing granules. The durability of the resulting coating measured using the Coating Durability Test described in the Examples section may be more than about 70%, more preferably more than about 90%, and most preferably about 100%.

### DETAILED DESCRIPTION

The present invention is directed to a coating composition comprising photocatalytic particles and an alkali metal silicate binder comprising an alkoxysilane and a coated article having a photocatalytic coating with improved durability. In the present invention, the durability of a photocatalytic coating is characterized using the Coating Durability Test described in the Examples section.

The photocatalytic coating is formed by applying the coating composition onto the base article, followed by heating to elevated temperatures of at least about 170° C. and up to about 650° C., with a preferred temperature of about 200° C. to about 450° C. The coating protects the base article against discoloration caused by algae growth or other agents. For purposes of the present invention, the coating may have multiple layers.

Base articles suitable for use with the present invention can be any ceramic, metallic, or polymeric materials or composites thereof that are capable of withstanding temperatures of at least about 170° C. Preferred articles include building materials that are susceptible to discoloration due to algae infestation or other agents, such as airborne particulates of dust, dirt, soot, pollen or the like. Examples include roofing materials, concrete and cement based materials, plasters, asphalts, ceramics, stucco, grout, plastics, metals or coated metals, glass, or combinations thereof. Additional examples include pool surfaces, wall coverings, siding materials, flooring, filtration systems, cooling towers, buoys, seawalls, retaining walls, boat hulls, docks, and canals. One particularly preferred article is roofing granules, such as those formed from igneous rock, argillite, greenstone, granite, trap rock, silica sand, slate, nepheline syenite, greystone, crushed quartz, slag, or the like, and having a particle size in the range from about 300 μm to about 5000 μm in diameter. Roofing granules are often partially embedded onto a base roofing material, such as, for example, asphalt-impregnated shingles, to shield the base material from solar and environmental degradation. Another particularly preferred article is tiles, such as those formed from ceramics, stones, porcelains, metals, polymers, or composites thereof. Tiles are often used for covering roofs, ceilings, floors, and walls, or other objects such as tabletops to provide wear, weather and/or fire resistances.

Photocatalysts are included in the coating composition of the present invention. Upon activation or exposure to sunlight, photocatalysts are thought to establish both oxidation and reduction sites. These sites are thought to produce highly reactive species such as hydroxyl radicals that are capable of preventing or inhibiting the growth of algae or other biota on the coated article, especially in the presence of water. Many photocatalysts conventionally recognized by those skilled in the art are suitable for use with the present invention. Preferred photocatalysts include transition metal photocatalysts. Examples of suitable transition metal photocatalysts include TiO₂, ZnO, WO₃, SnO₂, CaTiO₃, Fe₂O₃, MoO₃, Nb₂O₅, TiₓZr₍₁₋ₓ₎O₂, SiC, SrTiO₃, CdS, GaP, InP, GaAs, BaTiO₃, KNbO₃, Ta₂O₅, Bi₂O₃, NiO, Cu₂O, SiO₂, MoS₂, InPb, RuO₂, CeO₂, Ti(OH), and combinations thereof. Particularly preferred photocatalysts include crystalline anatase TiO₂, crystalline rutile TiO₂, crystalline ZnO and combinations thereof.

To improve spectral efficiency, photocatalysts may be doped with a nonmetallic element, such as C, N, S, F, or with a metal or metal oxide, such as Pt, Pd, Au, Ag, Os, Rh, RuO₂, Nb, Cu, Sn, Ni, Fe, or combinations thereof.

Photocatalytic particles may be characterized by mean particle size which can be determined using electron microscopy under ASTM D3849. The present invention typically uses photocatalytic particles having a mean particle size in the range of about 1 nm to about 1000 nm. Preferred mean particle size is in the range of about 1 nm to about 200 nm, with a most preferred range of about 1 nm to about 100 nm. Such photocatalytic particles have relatively large surface area per weight of particles and thus likely provide high photoactivity.

The coating composition of the present invention has a solid weight percentage of photocatalytic particles in the range of about 0.1% to about 90%. Preferred weight percentage is in the range of about 30% to about 80%, with a most preferred range of about 40% to about 70%.

Examples of suitable alkali metal silicate binders include lithium silicate, sodium silicate, potassium silicate, and combinations thereof. Alkali metal silicate is generally denoted as M₂O: SiO₂, where M is lithium, sodium, or potassium. The weight ratio of SiO₂ to M₂O may range from about 1.4:1 to about 3.75:1. A preferred weight ratio is in the range of about 2.75:1 to about 3.22:1.

The alkali metal silicate binder comprises an alkoxysilane. Typical alkoxysilane compounds useful in the present invention include those having a structural unit of Si(R₁)ₙ(OR₂)₄₋ₙ or dimers or oligomers formed from this structural unit or combinations thereof, where R₁ and R₂ are independent organic groups having carbon number from 1 to 18, and n is an integer from 0 to 2. As used herein, the term “organic group” means a hydrocarbon group (with optional elements other than carbon and hydrogen, such as oxygen, nitrogen, sulfur, and halogens) such as aliphatic groups, cyclic groups, or combinations of aliphatic and cyclic groups (e.g., alkaryl and aralkyl groups). The term “aliphatic group” means a saturated or unsaturated linear or branched hydrocarbon group. This term encompasses, for example, alkyl, alkenyl and alkynyl groups. The term “alkyl group” means a saturated linear or branched hydrocarbon group including, for example, methyl, ethyl, isopropyl, t-butyl, hexyl, heptyl, dodecyl, octadecyl, amyl, 2-ethylhexyl, and the like. The term “alkenyl group” means an unsaturated linear or branched hydrocarbon group with one or more carbon-carbon double bonds, such as a vinyl group. The term “alkynyl group” means an unsaturated linear or branched hydrocarbon group with one or more carbon-carbon triple bonds. The term “cyclic group” means a closed ring hydrocarbon group that is classified as an alicyclic group, aromatic group, or heterocyclic group. The term “alicyclic group” means a cyclic hydrocarbon group having properties resembling those of aliphatic groups. The term “aromatic group” or “aryl group” means a mono or polynuclear aromatic hydrocarbon group, including alkaryl and aralkyl groups. The term “heterocyclic group” means a closed ring hydrocarbon in which one or more of the atoms in the ring is an element other than carbon (e.g., nitrogen, oxygen, sulfur, etc.).

Examples of suitable alkoxysilanes include methyltrimethoxysilane, methyltriethoxysilane, ethyltrimethoxysilane, ethyltriethoxysilane, propyltrimethoxysilane, propyltriethoxysilane, isobutyltrimethoxysilane, pentyltriethoxysilane, octyltriethoxysilane, octadecyltrimethoxysilane, octadecyltriethoxysilane, phenyltriethoxysilane, vinyltrimethoxysilane, and vinyltriethoxysilane, tetramethoxysilane, tetraethoxysilane, tetrapropoxysilane, tetraisopropoxysilane, tetrabutoxysilane, tetrakis(s-butoxy)silane, tetrakis(2-ethyl-butoxy)silane, tetrakis(2-ethyl-hexoxy)silane, tetrakis(2-methoxy-ethoxy)silane, tetraphenoxysilane, hexaethoxydisiloxane, tetracetoxysilane, methyltriacetoxysilane, ethyltriacetoxysilane, di-t-butoxydiacetoxysilane, and combinations thereof. A preferred alkoxysilane is tetraethoxysilane (TEOS).

The use of an alkoxysilane enhances the durability of the photocatalytic coating. Traditional approach to improving the durability of photocatalytic coatings is to increase the amount of alkali metal silicate used in the coating composition. In general, this has the effect of reducing the photoactivity of the coating, and in some cases, may also lighten the color. In contrast, the use of tetraethoxysilane (TEOS) in the present invention produces good binding durability between, for example, the TiO2 particles and the base granules. Consequently, the resulting photocatalytic coating has relatively long-term photocatalytic performance without substantially sacrificing vivid color and high photoactivity of the coated granules. Specifically, the use of tetraethoxysilane (TEOS) in the present invention can result that the durability of the photocatalytic coating as measured using the Coating Durability Test described in the Examples section is more than about 70%, more preferably more than about 90%, and most preferably about 100%. To achieve enhanced durability, the solid weight percentage of the alkoxysilane in the coating composition is typically more than about 0.1%. The preferred weight percentage is more than about 10%, with a most preferred percentage of more than about 15%.

The durability of the photocatalytic coating can also be enhanced by adding a boric acid, borate, or combination thereof to the coating composition, as disclosed in 3M Patent Application No. 62617US002, filed on Dec. 22, 2006, the entirety of which is incorporated herein by reference.

A pigment, or combination of pigments, may be included in the coating composition to achieve a desired color. Suitable pigments include conventional pigments, such as carbon black, titanium dioxide, chromium oxide, yellow iron oxide, phthalocyanine green and blue, ultramarine blue, red iron oxide, metal ferrites, and combinations thereof.

The photocatalytic coating of the present invention can be transparent, as disclosed in 3M Patent Application No. 62618US002, filed on Dec. 22, 2006, the entirety of which is incorporated herein by reference.

### EXAMPLES

The operation of the present invention will be further described with regard to the following detailed examples. These examples are offered to further illustrate the various specific and preferred embodiments and techniques. It should be understood, however, that many variations and modifications may be made while remaining within the scope of the present invention.

### Photocatalytic Activity Test

The granules were sieved through a −16/+20 mesh, washed 5 times by deionized water and then dried at 240° F. (˜116° C.) for about 20 minutes. 40 g of the dried granules was placed into a 500 mL crystallization dish. 500 g of 4×10⁻⁴ M aqueous disodium terephthalate solution was then added to the dish. The mixture was stirred using a magnetic bar placed in a submerged small Petri dish and driven by a magnetic stirrer underneath the crystallization dish. The mixture was exposed to UV light produced by an array of 4, equally spaced, 4-ft (1.2-m) long black light bulbs (Sylvania 350 BL 40W F40/350BL) that were powered by two specially designed ballasts (Action Labs, Woodville, Wis.). The height of the bulbs was adjusted to provide about 2.3 mW/cm² UV flux measured using a VWR Model 21800-016 UV Light Meter (VWR International, West Chester, Pa.) equipped with a UVA Model 365 Radiometer (Solar Light Company, Glenside, Pa.) having a wavelength band of 320-390 nm.

During irradiation, about 3 mL of the mixture was removed with a pipet at about 5-minute intervals and transferred to a disposable 4-window polymethylmethacrylate or quartz cuvette. The mixture in the cuvette was then placed into a Fluoromax-3 spectrofluorimeter (Jobin Yvon, Edison, N.J.). The fluorescence intensity measured at excitation wavelength of 314 nm and emission wavelength of 424 nm was plotted against the irradiation time. The slope of the linear portion (the initial 3-5 data points) of the curve was indicative of the photocatalytic activity of the mixture. A comparison of this slope with that for the aqueous disodium terephthalate solution provided the relative photoactivity of the granules as reported. In general, the larger the reported value, the greater the photoactivity of the granules.

### Coating Durability Test

The granules were sieved through a −16/+20 mesh. 50 g of the granules without washing was added to a four oz. glass jar. The jar was then placed onto a motorized roller (available from Bodine Electric Company, Chicago, Ill.) tilted at an angle of about 17 degree to the floor plane and kept rolling for one hour at a rolling speed of about 35 rpm. The rolled granules were washed with deionized water and their photoactivity was measured according to the Photocatalytic Activity Test described above. The photoactivity of the unrolled granules was also measured. The photoactivity ratio (expressed in percentage) of the rolled granules to the unrolled granules was reported as “durability”. The higher the ratio, the more durable the coating.

### Working Example 1 and Comparative Examples A-D

The sample for Working Example 1 was prepared as follows. 1.50 g of aqueous dispersion of TiO2 (STS-21, available from Ishihara Sangyo Kaisha, Japan), 50.59 g of deionized water, 0.75 g of sodium silicate (Sodium Silicate PD, 37 wt % with 2.75 wt % ratio of SiO₂/Na₂O, available from PQ Corporation, Valley Forge, Pa.), and 8.66 g of a freshly prepared dispersion of tetraethoxysilane (TEOS, 98%, available from Sigma-Aldrich, St. Louis, Mo.) in ethanol/water (the molar ratio of the dispersion is TEOS:EtOH:H₂O=1:40.7:53.6) were added to a 250 mL vessel and mixed well. The resulting mixture was then slowly poured onto 1000 g of stirring WA 5100 granules (untreated, available from 3M Company, St. Paul, Minn.), which had been pre-heated to 210° F. (˜99° C.) for one hour. While pouring, the granules were mixed to ensure an even coating. The granules were further stirred for about 2 minutes. The granules were then heated with a heat gun until they appeared to be dry and loose. The dried granules were then fired in a rotary kiln (natural gas/oxygen flame) to 800° F. (˜427° C.), and removed and allowed to cool to room temperature. The samples for Comparative Examples A-D were prepared using the same procedure except that different coating compositions were used. The compositions of the photocatalytic coatings for Working Example 1 and Comparative Examples A-D are listed in Table 1.

The durability of the cooled granules was measured according to the testing procedure described above, and reported in Table 1. The results show that use of tetraethoxysilane (TEOS) in combination with sodium silicate substantially increases the durability.

TABLE 1
Compositions of Photocatalytic Coating and Durability of Coated Granules for Working
Example 1 and Comparative Examples A-D.

| | | | Sodium | | Tetraethoxysilane | Firing | | |
|---|---|---|---|---|---|---|---|---|
| | STS-21 | DI H₂O | Silicate PD | Clay | Mixture | Temp | Photoactivity | Durability |
| Example | (g) | (g) | (g) | (g) | (g) | (° F.) | (before rolling) | (%) |
| 1 | 1.50 | 50.59 | 0.75 | 0 | 8.66 | 800 | 1.44 × 10⁵ | 100 |
| A | 1.50 | 60.00 | 0.75 | 0.19^{a} | 0 | 800 | 1.87 × 10⁵ | 58 |
| B | 1.50 | 60.00 | 0.75 | 0.19^{b} | 0 | 800 | 2.15 × 10⁵ | 64 |
| C | 1.50 | 51.34 | 0 | 0 | 8.66 | 800 | 2.47 × 10⁵ | 65 |
| D | 1.50 | 51.15 | 0 | 019^{b} | 8.66 | 800 | 2.16 × 10⁵ | 61 |

^{a}Dover clay, available from Grace Davison, Columbia, Maryland.
^{b}Cloisite 20A clay, available from Southern Clay Products, Gonzales, TX.

### Working Examples 2-5

The samples for Working Examples 2-5 were prepared using the same procedure as that for preparing the sample for Working Example 1. The compositions of the photocatalytic coatings for Working Examples 2-5 are listed in Table 2. Compared with Working Example 1, Grade #11 uncoated granules (available from 3M Company, St. Paul, Minn.) were used in Working Examples 2-5. Furthermore, the samples for Working Examples 3&5 were fired at 400° F. (˜204° C.) instead of 800° F.

The durability of the coated granules was measured and reported in Table 2. The results also show that use of tetraethoxysilane (TEOS) in combination with sodium silicate substantially increases the durability.

TABLE 2
Compositions of Photocatalytic Coating and Durability of Coated Granules for Working
Examples 2-5.

| | | | Sodium | Potassium | Tetraethoxysilane | Firing | | |
|---|---|---|---|---|---|---|---|---|
| | STS-21 | DI H₂O | Silicate PD | Tetrafluoroborate | Mixture | Temp | Photoactivity | Durability |
| Example | (g) | (g) | (g) | (g) | (g) | (° F.) | (before rolling) | (%) |
| 2 | 1.50 | 50.59 | 0.75 | 0 | 8.66 | 800 | 3.88 × 10⁵ | 96 |
| 3 | 1.50 | 50.59 | 0.75 | 0 | 8.66 | 400 | 3.46 × 10⁵ | 93 |
| 4 | 1.50 | 50.59 | 0.75 | 0.11 | 8.66 | 800 | 3.37 × 10⁵ | 88 |
| 5 | 1.50 | 50.59 | 0.75 | 0.11 | 8.66 | 400 | 3.46 × 10⁵ | 97 |

### Working Examples 6-9

The samples for Working Examples 6-9 were prepared using the same procedure as that for preparing the sample for Working Example 1. The compositions of the photocatalytic coatings for Working Examples 6-9 are listed in Table 3. Compared with Working Example 1, Grade #11 uncoated granules were used in Working Examples 6-9. Also, an acidic aqueous TEOS solution was used in Working Examples 6-9. This solution was prepared by adding 43.20 g of deionized water, 10.00 g of 98% TEOS, and one drop of 68-70% nitric acid assay (HNO₃) (available from EM Industries, Gibbstown, N.J.) to a 100 mL glass bottle, followed by magnetic stirring at room temperature for 60 minutes. Furthermore, potassium silicate was used in Working Examples 7&8 in place of sodium silicate. Moreover, the samples for Working Examples 8&9 were fired at 500° F. (260° C.) instead of 800° F.

The durability of the coated granules was measured and reported in Table 3. The results show that use of tetraethoxysilane (TEOS) in combination with sodium or potassium silicate leads to excellent durability.

TABLE 3
Compositions of Photocatalytic Coating and Durability of Coated Granules for Working
Examples 6-9.

| | | | | Tetraethoxysilane | Firing | | |
|---|---|---|---|---|---|---|---|
| | STS-21 | DI H₂O | Silicate | Mixture | Temp | Photoactivity | Durability |
| Example | (g) | (g) | (g) | (g) | (° F.) | (before rolling) | (%) |
| 6 | 1.50 | 50.59 | 0.75^{a} | 3.15 | 800 | 4.16 × 10⁵ | 84 |
| 7 | 1.50 | 50.59 | 1.44^{b} | 3.15 | 800 | 3.98 × 10⁵ | 90 |
| 8 | 1.50 | 50.59 | 0.75^{a} | 3.15 | 500 | 4.07 × 10⁵ | 91 |
| 9 | 1.50 | 50.59 | 1.44^{b} | 3.15 | 500 | 4.04 × 10⁵ | 91 |

^{a}Sodium Silicate PD.
^{b}Potassium Silicate Kasil 1, 28.91 wt % with 2.47 wt % ratio of SiO₂/K₂O, available from PQ Corporation.

The tests and test results described above are intended solely to be illustrative, rather than predictive, and variations in the testing procedure can be expected to yield different results. The present invention has now been described with reference to several embodiments thereof. The foregoing detailed description and examples have been given for clarity of understanding only. No unnecessary limitations are to be understood therefrom. All patents and patent applications cited herein are hereby incorporated by reference. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

1. A coated article, comprising:
an article having an external surface and a coating on the external surface of the article, wherein the coating is formed from a composition comprising between 30 weight % and 80 weight % crystalline anatase TiO₂ photocatalytic particles and an alkali metal silicate binder, wherein the alkali metal silicate binder further comprises an alkoxysilane, wherein the alkoxysilane comprises tetramethoxysilane, tetraethoxysilane, tetrapropoxysilane, tetraisopropoxysilane, tetrabutoxysilane, tetrakis(s-butoxy)silane, tetrakis(2-ethyl-butoxy)silane, tetrakis(2-ethyl-hexoxy)silane, tetrakis(2-methoxy-ethoxy)silane, tetraphenoxysilane, hexaethoxydisiloxane, tetracetoxysilane, and di-t-butoxydiacetoxysilane, or combinations thereof, and wherein the article is selected from the group consisting of a roofing granule or a tile.

2. The coated article of claim 1, wherein the photocatalytic particles further comprise ZnO, WO₃, SnO₂, CaTiO₃, Fe₂O₃, MoO₃, Nb₂O₅, TiₓZr₍₁₋ₓ₎O₂, SiC, SrTiO₃, CdS, GaP, InP, GaAs, BaTiO₃, KNbO₃, Ta₂O₅, Bi₂O₃, NiO, Cu₂O, SiO₂, MoS₂, InPb, RuO₂, CeO₂, Ti(OH)₄, or combinations thereof.

3. The coated article of claim 1, wherein the photocatalytic particles comprise crystalline rutile TiO₂, crystalline ZnO, or combinations thereof.

4. The coated article of claim 1, wherein the photocatalytic particles are doped with C, N, S, F, Pt, Pd, Au, Ag, Os, Rh, RuO2, Nb, Cu, Sn, Ni, Fe, or combinations thereof.

5. The coated article of claim 1, wherein the alkoxysilane comprises tetraethoxysilane.

6. The coated article of claim 1, wherein the durability of the coating measured using the Coating Durability Test is more than about 70%.

7. The coated article of claim 1, wherein the alkali metal silicate binder comprises lithium silicate, sodium silicate, potassium silicate, or combinations thereof

8. The coated article of claim 1, wherein the alkali metal silicate binder further comprises a pigment.

9. A coated roofing granule, comprising:
a roofing granule having an external surface and a coating on the external surface of the roofing granule, wherein the coating is formed from a composition comprising between 30 weight % and 80 weight % crystalline anatase photocatalytic TiO₂ particles and an alkali metal silicate binder, wherein the alkali metal silicate binder further comprises tetraethoxysilane, and the durability of the coating measured using the Coating Durability Test is more than about 70%.

10. A coating composition, comprising:
Between 30 weight % and 80 weight % crystalline anatase TiO2 photocatalytic particles and an alkali metal silicate binder, wherein the alkali metal silicate binder further comprises an alkoxysilane, wherein the alkoxysilane comprises tetramethoxysilane, tetraethoxysilane, tetrapropoxysilane, tetraisopropoxysilane, tetrabutoxysilane, tetrakis(s-butoxy)silane, tetrakis(2-ethyl-butoxy)silane, tetrakis(2-ethyl-hexoxy)silane, tetrakis(2-methoxy-ethoxy)silane, tetraphenoxysilane, hexaethoxydisiloxane, tetracetoxysilane, and di-t-butoxydiacetoxysilane, or combinations thereof, and wherein the alkali metal silicate binder comprises an alkali metal silicate selected from the group consisting of sodium silicate and potassium silicate.

11. The coating composition of claim 10, wherein the photocatalytic particles further comprise ZnO, WO₃, SnO₂, CaTiO₃, Fe₂O₃, MoO₃, Nb₂O₅, TiₓZr₍₁₋ₓ₎O₂, SiC, SrTiO₃, CdS, GaP, InP, GaAs, BaTiO₃, KNbO₃, Ta₂O₅, Bi₂O₃, NiO, Cu₂O, SiO₂, MoS₂, InPb, RuO₂, CeO₂, Ti(OH)₄, or combinations thereof.

12. The coating composition of claim 10, wherein the photocatalytic particles further comprise crystalline rutile TiO₂, crystalline ZnO, or combinations thereof

13. The coating composition of claim 10, wherein the photocatalytic particles are doped with C, N, S, F, Pt, Pd, Au, Ag, Os, Rh, RuO₂, Nb, Cu, Sn, Ni, Fe, or combinations thereof.

14. The coating composition of claim 10, wherein the alkoxysilane comprises tetraethoxysilane.

15. The coating composition of claim 10, wherein the alkali metal silicate binder further comprises a pigment.
